(19) United States
(12) Patent Application Publication
(10) Pub. No.: US 2024/0157290 A1
(43) Pub. Date: May 16, 2024

(54) DIRECT AIR-CO2-CAPTURED VIA AMMONIA PLANTS

(71) Applicant: Qatar Foundation for Education, Science and Community Development, Doha (QA)

(72) Inventors: Abdulkrem Amhamed, Doha (QA); Odi Fawwaz Alrebei, Doha (QA); Mohammad Al-Kuwari, Doha (QA); Ahmed Sodiq, Doha (QA); Yasser Abdellatif, Doha (QA)

(21) Appl. No.: 18/388,971

(22) Filed: Nov. 13, 2023

Related U.S. Application Data
(60) Provisional application No. 63/425,152, filed on Nov. 14, 2022.

(51) Int. Cl. B01D 53/62; C01C 1/02

(52) U.S. Cl. CPC B01D 53/62; C01C 1/02; B01D 2257/504

(57) ABSTRACT

A system includes a direct air capture (DAC) system, and an ammonia production system in communication with the DAC system. The DAC system includes an air contactor configured to capture carbon dioxide in air. The ammonia production system includes a reforming process and a combustion process. The ammonia production system is supplied with an air stream including a first air stream configured to be supplied into the reforming process. The DAC system is in communication with the ammonia production system through the first air stream.

### PRIORITY CLAIM

The present application claims priority to and the benefit of U.S. Provisional Patent Applications No. 63/425,152, filed on Nov. 14, 2022, the entirety of which is incorporated herein by reference.

### BACKGROUND

There has been a global scientific and industrial effort in utilizing ammonia as an alternative to natural gas combustion to run power plants. Some of the main efforts for improving the ammonia plants may include a) reducing ammonia-production-related energy consumption through renewable and sustainable approaches; b) techno-economics of ammonia production; c) proposing alternative approaches to supply nitrogen and hydrogen to the process; d) advancing ammonia production catalysts; e) altering the cycle configuration (design or/and operating conditions); 0 environmental aspects and ammonia-production-related carbon reduction.

### SUMMARY

The present disclosure generally relates to a system and method for a direct capture of CO₂ in an ammonia production system. In light of the present disclosure, and without limiting the scope of the disclosure in any way, in an aspect of the present disclosure, which may be combined with any other aspect listed herein unless specified otherwise, a system for a direct capture of CO₂ in an ammonia production system is provided. The system includes a direct air capture (DAC) system, and an ammonia production system in communication with the DAC system. The DAC system includes an air contactor configured to capture carbon dioxide in air. The ammonia production system includes a reforming process and a combustion process. The ammonia production system is supplied with an air stream including a first air stream configured to be supplied into the reforming process. The DAC system is in communication with the ammonia production system through the first air stream.

The reader will appreciate the foregoing details, as well as others, upon considering the following detailed description of certain non-limiting embodiments including a system and method for a direct capture of CO₂ in an ammonia production system according to the present disclosure.

### BRIEF DESCRIPTION OF THE FIGURES

FIG. 1 illustrates an example system for a direct capture of CO₂ according to an example of the present disclosure.

FIGS. 2A and 2B are graphs showing CO₂ flow rates from reforming flue gas (FIG. 2A) and combustion flue gas (FIG. 2B) of systems according to scenarios described in Table 1.

FIGS. 3A and 3B are graphs showing heat duties of a combustion process (FIG. 3A) and a reforming process (FIG. 3B) of the systems according to the scenarios described in Table 1.

### DETAILED DESCRIPTION

The present disclosure generally relates to a system and method for a direct capture of CO₂ in an ammonia production system. In particular, the present disclosure relates to a system and method of combining a direct air capture (DAC) system with an ammonia production plant.

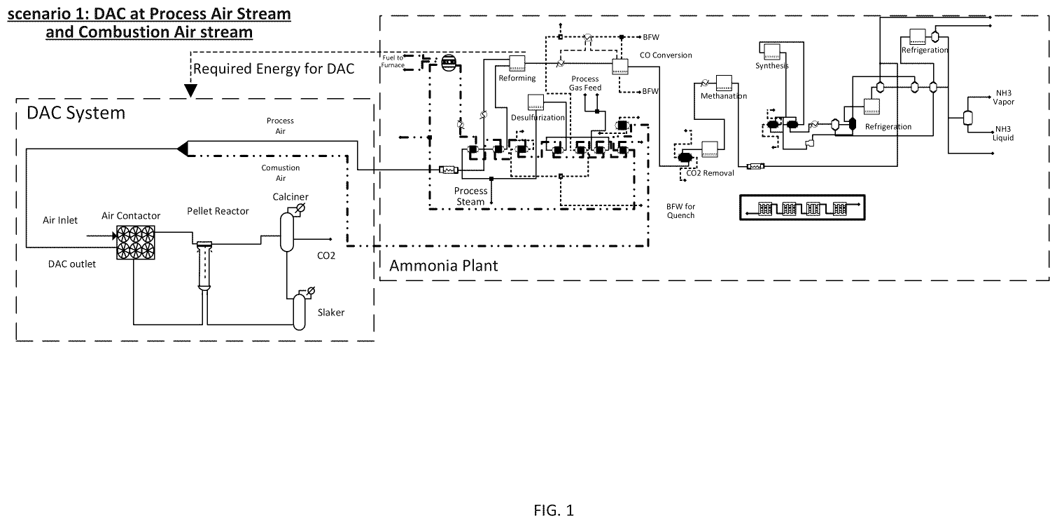

According to an embodiment of the present disclosure, a system and method for a direct capture of CO₂ in Ammonia production plants is provided. FIG. 1 illustrates an example system for a direct capture of CO₂ according to an example of the present disclosure. As shown in FIG. 1, the system may include two subsystems: a Direct Air Capture (DAC) system for CO₂ capture and an ammonia production plant/system. The DAC subsystem may include one or more main units. The one or more main units of the DAC system may include an air contactor, a pellet reactor, a calciner, and/or a slaker. An example operation process of the DAC subsystem is discussed in detail below.

The air contactor of the DAC system may capture CO₂, for example, by forcing/allowing air to contact alkali liquid/solution. When the air contacts the alkali liquid/solution, a diffusion-reaction may occur to capture CO₂. In some examples, the mass transfer coefficient (KL) may be approximately 0.13 cm/s at 293 K.

The mixture content/alkali solution may include hydroxide (OH—), carbonate ion (CO₃²⁻), and potassium ion (K⁺). For example, the mixture content/alkali solution may include 1 M OH⁻, 0.5 M CO₃²⁻, and 2 M K⁺.

In some examples, in the air contactor, the carbon dioxide is reacted with potassium hydroxide (KOH) to produce potassium carbonate (K₂CO₃). For example, the resultant reaction that occurs in the air contactor of the DAC system may react every CO₂ mol with two mol of KOH to produce one mol of H₂O and one mol of K₂CO₃.

The resultant K₂CO₃ from the air contactor reaction may be transferred to the pellet reactor. In the pellet reactor, the potassium carbonate (K₂CO₃) may be reacted with calcium hydroxide (Ca(OH)) to produce potassium hydroxide (KOH) and calcium carbonate (CaCO₃). For example, in the pellet reactor, each mol of K₂CO₃ may be reacted with one mol of Ca(OH) in exothermic reaction (e.g., −5.8 KJ/mol) to produce two mol of KOH and one mole of CaCO₃.

The potassium hydroxide (KOH) from the pellet reactor may be recycled back to the air contactor. That is, the potassium hydroxide (KOH) from the pellet reactor may be supplied to the air contactor and used to react with the carbon dioxide to produce the potassium carbonate (K₂CO₃).

The calcium carbonate (CaCO₃) produced by the pellet reactor may be fed into the calciner. In the calciner, the calcium carbonate (CaCO₃) may be transformed into carbon dioxide (CO₂) and calcium oxide (CaO). For example, in the calciner, the calcium carbonate (CaCO₃) may be transformed into CO₂ and CaO in an endothermic process (e.g., +178.3 kJ/mol).

The calcium oxide (CaO) produced by the calciner may be supplied to the slaker. In the slaker, the calcium oxide (CaO) may be reacted with water (H₂O) to produce calcium hydroxide (CaOH). For example, in the slaker, each mole of CaO may be reacted with one mole of H₂O in exothermic process to produce CaOH.

The calcium hydroxide (CaOH) from the slaker may be recycled back to the pellet reactor. That is, the calcium hydroxide (CaOH) from the slaker may be supplied to the pellet reactor and used to react with the potassium carbonate (K₂CO₃) to produce potassium hydroxide (KOH) and calcium carbonate (CaCO₃).

The second subsystem according to the present disclosure may be an ammonia system (e.g., 585 MW ammonia plant). The ammonia system may include a reforming process, combustion process, desulfurization, CO conversion process, CO₂ removal process, methanation process, and/or an NH₃ synthesis loop.

The ammonia system may be fed with one or more air streams. The one or more air streams may include a first air stream that may feed the reforming process and a second air stream that may be supplied into the combustion process to provide the necessary heat duty to perform the reforming process.

The DAC system may be in communication with the ammonia production system through the first air stream and the second air stream. For example, the air contactor may include an outlet port configured to supply the first air stream and the second air stream to the ammonia production system. The air contactor may further include an inlet port configured to receive the air to capture the carbon dioxide.

In some examples, the first air stream (e.g., process air) may be a decarbonized air (e.g., air without CO₂). The second air stream (e.g., combustion air) may be a decarbonized air like the first air stream, however, the second air stream may fed into a furnace. In some examples, the first air stream and the second air stream may have the same contents, but they may just be split into two streams, each serving different purpose.

As discussed above, the first air stream may be fed into the reforming process of the ammonia production system and the reforming process may perform the following reactions:

3C₂H₆+H₂O→CH₄+CO (1)

3C₃H₈+2H₂O→7CH₄+2CO (2)

3N-butane+3H₂O→9CH₄+3CO (3)

3I-butane+3H₂O→9CH₄+3CO (4)

3N-pentan+4H₂O→11CH₄+4CO (5)

3N-hexane+5H₂O→13CH₄+5CO (6)

2NH₃→N₂+3H₂ (7)

3I-pentan+4H₂O→11CH₄+4CO (8)

3N-heptne+6H₂O→15CH₄+6CO (9)

CH₄+2O₂→CO₂+2H₂O (10)

H₂+0.5O₂→H₂O (11)

The second air stream may be supplied into the combustion process of the ammonia production system to provide the necessary heat duty to perform the reforming process (reactions (1-11)). The combustion process may be described in the following reactions.

2NH₃+1.5O₂→N₂+3H₂O (12)

2H₂+O₂→H₂O (13)

CH₄+2O₂→CO₂+2H₂O (14)

2CO+O₂→2CO₂ (15)

C₂H₆+3.5O₂→2CO₂+3H₂O (16)

C₃H₈+5O₂→3CO₂+4H₂O (17)

N-butane+6.5O₂→4CO₂+5H₂O (18)

I-butane+6.5O₂→4CO₂+5H₂O (19)

N-pentan+8O₂→5CO₂+6H₂O (20)

N-hexane+9.5O₂→6CO₂+7H₂O (21)

I-pentan+8O₂→5CO₂+6H₂O (22)

N-heptne+11O₂→7CO₂+8H₂O (23)

Aspects of the present disclosure may apply the DAC system at the reforming process air stream and the combustion air stream of the ammonia production system.

### EXAMPLE

In this example, a DAC system is combined with an ammonia production system in various scenarios as shown in Table 1 below.

TABLE 1
Direct Air-CO₂-Captured Scenarios
in Ammonia Production System

| Description: | Scenario |
|---|---|
| Without Using DAC | Control Case |
| DAC at reforming process air stream and | Scenario 1 |
| combustion air stream | |
| DAC at process air stream | Scenario 2 |
| DAC at combustion air stream | Scenario 3 |
| DAC at process air with CO₂ feed to the | Scenario 4 |
| combustion air stream | |
| DAC at the combustion air stream with CO₂ | Scenario 5 |
| feed to the process air stream | |

The system according to scenario 1 is illustrated in FIG. 1. The systems in these various scenarios have been tested (using ASPEN PLUS) with respect to their effects on the flue gases of the reforming and combustion processes and the consumed power. These tests were conducted in ASPEN PLUS by applying the parameters of the decarbonized air streams in the ammonia production process as per the scenarios described in Table 1.

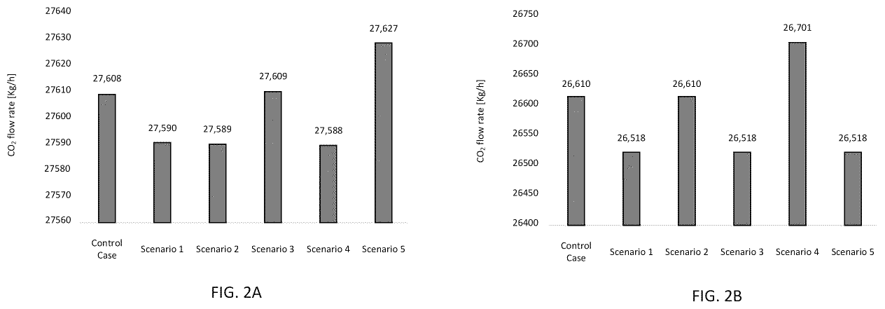

FIGS. 2A and 2B show each system's CO₂ flow rates from reforming flue gas (FIG. 2A) and combustion flue gas (FIG. 2B). As shown in FIG. 2A, compared to the control case (e.g., ammonia production system without DAC), CO₂ flow rates in the reforming flue gas in the systems according to scenarios 1, 2, and 4 are reduced by approximately 18 kg/h, 19 kg/h and 20 kg/h, respectively. However, as shown in FIG. 2B, compared to the control case, while the system according to scenario 2 does not seem to have an impact on reducing CO₂ flow rates of the combustion flue gas, the system according to scenario 4 has a negative impact on reducing CO₂ flow rates of the combustion flue gas (i.e., increases the CO₂ flow rates by approximately 91 kg/h). It is noted that the system according to scenario 1 reduces CO₂ flow rates in both of the reforming process (by approximately 18 kg/h) and the combustion process (i.e., 92 kg/h) compared to the control case.

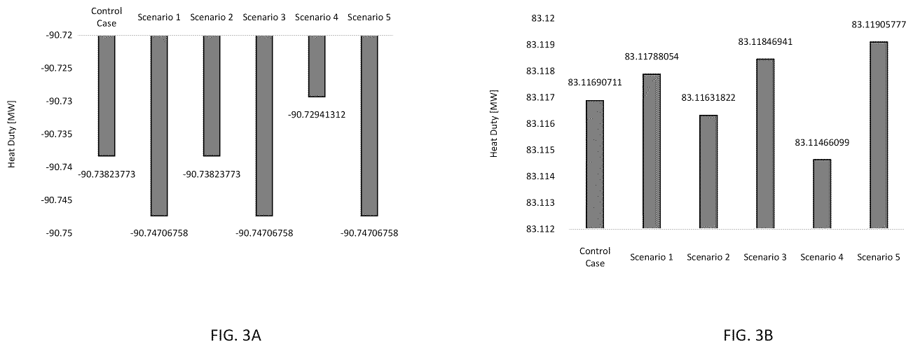

The effect on energy consumption has been estimated by applying the composition of the decarbonized air streams on the combustion and reforming process of the ammonia production system in each of the systems described in Table 1 above. FIGS. 3A and 3B show the heat duties of the combustion process (FIG. 3A) and the reforming process (FIG. 3B) of the systems according to the scenarios described in Table 1.

As shown in FIGS. 3A and 3B, the system according to Scenario 1 increases the heat release from the combustion process by approximately 0.00883 MW and increases the required heat duty in the reforming process by only approximately 0.000973 MW. Thus, by applying the composition of the decarbonized air streams on the combustion and reforming processes, the required heat duty could be reduced by approximately 0.00786 MW accumulatively.

The system according to Scenario 1 may consume approximately 8.81GJ of natural gas to capture 1 tone of CO₂, which is approximately equivalent to 2.45 MWh. for capturing 1 tone of CO₂, the corresponding air to capture this content of CO₂ may be approximately 2194000 kg/h. This essentially means that for each 2194000 kg/h of air, 1 tone of CO₂ will be captured using approximately 2.45 MWh. The system according to Scenario 1 may require approximately 298800 kg/h of air flow; thus, approximately 0.33332 MW will be consumed to capture CO₂ as described in FIGS. 3A and 3B.

Given that the system according to Scenario 1 may reduce the required heat duty by approximately 0.00786 MW and running the DAC system may consume approximately 0.33332 MW, the overall power consumption may be estimated to be approximately 0.32546 MW (which is approximately 0.055% of the total consumption of the ammonia plant) to capture 18 kg/h and 92 kg/h of CO₂ from the combustion and reforming process, respectively.

### EMBODIMENTS

Various aspects of the subject matter described herein are set out in the following numbered embodiments:

Embodiment 1. A system, comprises: a direct air capture (DAC) system; and an ammonia production system in communication with the DAC system, wherein the DAC system comprises an air contactor configured to capture carbon dioxide in air, wherein the ammonia production system comprises: a reforming process; and a combustion process, wherein the ammonia production system is supplied with an air stream comprising a first air stream configured to be supplied into the reforming process, wherein the DAC system is in communication with the ammonia production system through the first air stream.

Embodiment 2. The system of embodiment 1, wherein the air contactor comprises: an inlet port configured to receive the air to capture the carbon dioxide; and an outlet port configured to supply the first air stream to the ammonia production system.

Embodiment 3. The system of any one of embodiments 1-2, wherein the air stream further comprises a second air stream configured to be supplied into the combustion process.

Embodiment 4. The system of embodiment 3, wherein the DAC system is further in communication with the ammonia production system through the second air stream.

Embodiment 5. The system of embodiment 4, wherein the air contactor comprises: an inlet port configured to receive the air to capture the carbon dioxide; and an outlet port configured to supply the second air stream to the ammonia production system.

Embodiment 6. The system of any one of embodiments 1-5, wherein the air contactor captures the carbon dioxide in the air by allowing the air to contact an alkali solution.

Embodiment 7. The system of embodiment 6, wherein the alkali solution comprises hydroxide (OH), carbonate ion (CO₃²⁻), and potassium ion (K⁺), wherein, in the air contactor, the carbon dioxide is reacted with potassium hydroxide (KOH) to produce potassium carbonate (K₂CO₃).

Embodiment 8. The system of embodiment 7, wherein the DAC system further comprises a pellet reactor configured to receive the potassium carbonate (K₂CO₃) produced by the air contactor, wherein, in the pellet reactor, the potassium carbonate (K₂CO₃) is reacted with calcium hydroxide (Ca(OH)) to produce potassium hydroxide (KOH) and calcium carbonate (CaCO₃).

Embodiment 9. The system of embodiment 8, wherein the potassium hydroxide (KOH) from the pellet reactor is supplied to the air contactor.

Embodiment 10. The system of any one of embodiments 8-9, wherein the DAC system further comprises a calciner configured to receive the calcium carbonate (CaCO₃) produced by the pellet reactor, wherein, in the calciner, the calcium carbonate (CaCO₃) is transformed into carbon dioxide (CO₂) and calcium oxide (CaO).

Embodiment 11. The system of embodiment 10, wherein the DAC system further comprises a slacker configured to receive the calcium oxide (CaO) produced by the calciner, wherein, in the slacker, the calcium oxide (CaO) is reacted with water (H₂O) to produce calcium hydroxide (CaOH).

Embodiment 12. The system of embodiment 11, wherein the calcium hydroxide (CaOH) produced by the slacker is supplied to the pellet reactor.

Embodiment 13. The system of any one of embodiments 1-12, wherein the ammonia production system further comprises at least one of a desulfurization process, a CO conversion process, a CO₂ removal process, a methanation process, and an NH₃ synthesis loop.

Embodiment 14. A system, comprises: a direct air capture (DAC) system; and an ammonia production system in communication with the DAC system, wherein the DAC system comprises an air contactor configured to capture carbon dioxide in air, wherein the ammonia production system comprises: a reforming process; and a combustion process, wherein the ammonia production system is supplied with an air stream comprising: a first air stream configured to be supplied into the reforming process; and a second air stream configured to be supplied into the combustion process, wherein the DAC system is in communication with the ammonia production system through the first air stream and the second air stream.

Embodiment 15. The system of embodiment 14, wherein the air contactor comprises: an inlet port configured to receive the air to capture the carbon dioxide; and an outlet port configured to supply the first air stream and the second air stream to the ammonia production system.

Embodiment 16. The system of any one of embodiments 14-15, wherein the air contactor captures the carbon dioxide in the air by allowing the air to contact an alkali solution comprising hydroxide (OH), carbonate ion (CO₃²⁻), and potassium ion (K⁺), wherein, in the air contactor, the carbon dioxide is reacted with potassium hydroxide (KOH) to produce potassium carbonate (K₂CO₃).

Embodiment 17. The system of embodiment 16, wherein the DAC system further comprises a pellet reactor configured to receive the potassium carbonate (K₂CO₃) produced by the air contactor, wherein, in the pellet reactor, the potassium carbonate (K₂CO₃) is reacted with calcium hydroxide (Ca(OH)) to produce potassium hydroxide (KOH) and calcium carbonate (CaCO₃), wherein the potassium hydroxide (KOH) from the pellet reactor is supplied to the air contactor.

Embodiment 18. The system of embodiment 17, wherein the DAC system further comprises a calciner configured to receive the calcium carbonate (CaCO₃) produced by the pellet reactor, wherein, in the calciner, the calcium carbonate (CaCO₃) is transformed into carbon dioxide (CO₂) and calcium oxide (CaO).

Embodiment 19. The system of embodiment 18, wherein the DAC system further comprises a slacker configured to receive the calcium oxide (CaO) produced by the calciner, wherein, in the slacker, the calcium oxide (CaO) is reacted with water (H₂O) to produce calcium hydroxide (CaOH), wherein the calcium hydroxide (CaOH) produced by the slacker is supplied to the pellet reactor.

Embodiment 20. The system of any one of embodiments 14-19, wherein the ammonia production system further comprises at least one of a desulfurization process, a CO conversion process, a CO₂ removal process, a methanation process, and an NH₃ synthesis loop.

While the conventional system may only prevent CO₂ emissions, the system according to the present disclosure may promote negative emissions. For example, the negative emissions of CO₂ can be achieved by taking from what is already existing in the atmosphere. Moreover, the hot air temperature can be reduced by taking part of generated heat from primary reformer and secondary reformer. For example, the system according to the present disclosure may utilize the waste heat from the ammonia production system to run the DAC system without additional energy consumption. Also, the system according to the present disclosure may store the pure recovered CO₂ in an ISO tank or use it directly as feed to Urea plant. The system according to the present disclosure may also supply the stored CO₂ to end-users for utilization.

As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Reference throughout the specification to “various aspects,” “some aspects,” “some examples,” “other examples,” “some cases,” or “one aspect” means that a particular feature, structure, or characteristic described in connection with the aspect is included in at least one example. Thus, appearances of the phrases “in various aspects,” “in some aspects,” “certain embodiments,” “some examples,” “other examples,” “certain other embodiments,” “some cases,” or “in one aspect” in places throughout the specification are not necessarily all referring to the same aspect. Furthermore, the particular features, structures, or characteristics illustrated or described in connection with one example may be combined, in whole or in part, with features, structures, or characteristics of one or more other aspects without limitation.

It is to be understood that at least some of the figures and descriptions herein have been simplified to illustrate elements that are relevant for a clear understanding of the disclosure, while eliminating, for purposes of clarity, other elements. Those of ordinary skill in the art will recognize, however, that these and other elements may be desirable. However, because such elements are well known in the art, and because they do not facilitate a better understanding of the disclosure, a discussion of such elements is not provided herein.

The terminology used herein is intended to describe particular embodiments only and is not intended to be limiting of the present disclosure. As used herein, the singular forms “a,” “an,” and “the” are intended to include the plural forms as well, unless otherwise indicated. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “at least one of X or Y” or “at least one of X and Y” should be interpreted as X, or Y, or X and Y.

It should be understood that various changes and modifications to the examples described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system, comprising:
a direct air capture (DAC) system; and
an ammonia production system in communication with the DAC system,
wherein the DAC system comprises an air contactor configured to capture carbon dioxide in air,
wherein the ammonia production system comprises:
a reforming process; and
a combustion process,
wherein the ammonia production system is supplied with an air stream comprising a first air stream configured to be supplied into the reforming process,
wherein the DAC system is in communication with the ammonia production system through the first air stream.

2. The system of claim 1, wherein the air contactor comprises:
an inlet port configured to receive the air to capture the carbon dioxide; and
an outlet port configured to supply the first air stream to the ammonia production system.

3. The system of claim 1, wherein the air stream further comprises a second air stream configured to be supplied into the combustion process.

4. The system of claim 3, wherein the DAC system is further in communication with the ammonia production system through the second air stream.

5. The system of claim 4, wherein the air contactor comprises:
an inlet port configured to receive the air to capture the carbon dioxide; and
an outlet port configured to supply the second air stream to the ammonia production system.

6. The system of claim 1, wherein the air contactor captures the carbon dioxide in the air by allowing the air to contact an alkali solution.

7. The system of claim 6, wherein the alkali solution comprises hydroxide (OH), carbonate ion (CO₃²⁻), and potassium ion (K⁺), wherein, in the air contactor, the carbon dioxide is reacted with potassium hydroxide (KOH) to produce potassium carbonate (K₂CO₃).

8. The system of claim 7, wherein the DAC system further comprises a pellet reactor configured to receive the potassium carbonate (K₂CO₃) produced by the air contactor, wherein, in the pellet reactor, the potassium carbonate (K₂CO₃) is reacted with calcium hydroxide (Ca(OH)) to produce potassium hydroxide (KOH) and calcium carbonate (CaCO₃).

9. The system of claim 8, wherein the potassium hydroxide (KOH) from the pellet reactor is supplied to the air contactor.

10. The system of claim 8, wherein the DAC system further comprises a calciner configured to receive the calcium carbonate (CaCO₃) produced by the pellet reactor, wherein, in the calciner, the calcium carbonate (CaCO₃) is transformed into carbon dioxide (CO₂) and calcium oxide (CaO).

11. The system of claim 10, wherein the DAC system further comprises a slaker configured to receive the calcium oxide (CaO) produced by the calciner, wherein, in the slaker, the calcium oxide (CaO) is reacted with water (H₂O) to produce calcium hydroxide (CaOH).

12. The system of claim 11, wherein the calcium hydroxide (CaOH) produced by the slaker is supplied to the pellet reactor.

13. The system of claim 1, wherein the ammonia production system further comprises at least one of a desulfurization process, a CO conversion process, a CO₂ removal process, a methanation process, and an NH₃ synthesis loop.

14. A system, comprising:
a direct air capture (DAC) system; and
an ammonia production system in communication with the DAC system,
wherein the DAC system comprises an air contactor configured to capture carbon dioxide in air,
wherein the ammonia production system comprises:
a reforming process; and
a combustion process,
wherein the ammonia production system is supplied with an air stream comprising:
a first air stream configured to be supplied into the reforming process; and
a second air stream configured to be supplied into the combustion process,
wherein the DAC system is in communication with the ammonia production system through the first air stream and the second air stream.

15. The system of claim 14, wherein the air contactor comprises:
an inlet port configured to receive the air to capture the carbon dioxide; and
an outlet port configured to supply the first air stream and the second air stream to the ammonia production system.

16. The system of claim 14, wherein the air contactor captures the carbon dioxide in the air by allowing the air to contact an alkali solution comprising hydroxide (OH⁻), carbonate ion (CO₃²⁻), and potassium ion (K⁺), wherein, in the air contactor, the carbon dioxide is reacted with potassium hydroxide (KOH) to produce potassium carbonate (K₂CO₃).

17. The system of claim 16, wherein the DAC system further comprises a pellet reactor configured to receive the potassium carbonate (K₂CO₃) produced by the air contactor, wherein, in the pellet reactor, the potassium carbonate (K₂CO₃) is reacted with calcium hydroxide (Ca(OH)) to produce potassium hydroxide (KOH) and calcium carbonate (CaCO₃), wherein the potassium hydroxide (KOH) from the pellet reactor is supplied to the air contactor.

18. The system of claim 17, wherein the DAC system further comprises a calciner configured to receive the calcium carbonate (CaCO₃) produced by the pellet reactor, wherein, in the calciner, the calcium carbonate (CaCO₃) is transformed into carbon dioxide (CO₂) and calcium oxide (CaO).

19. The system of claim 18, wherein the DAC system further comprises a slaker configured to receive the calcium oxide (CaO) produced by the calciner, wherein, in the slaker, the calcium oxide (CaO) is reacted with water (H₂O) to produce calcium hydroxide (CaOH), wherein the calcium hydroxide (CaOH) produced by the slaker is supplied to the pellet reactor.

20. The system of claim 14, wherein the ammonia production system further comprises at least one of a desulfurization process, a CO conversion process, a CO₂ removal process, a methanation process, and an NH₃ synthesis loop.
